(19) United States
(12) Patent Application Publication
(10) Pub. No.: US 2011/0067306 A1
(43) Pub. Date: Mar. 24, 2011

(54) Processes and Apparatuses for Reducing Pollutants and Producing Syngas

(75) Inventors: Maria Balmas, Hacienda Heights, CA (US); Henry Chan, Fountain Valley, CA (US)

(73) Assignee: BP CORPORATION NORTH AMERICA INC., Warrenville, IL (US)

(21) Appl. No.: 12/562,182

(22) Filed: Sep. 18, 2009

(51) Int. Cl. C10J 3/48; C10J 3/46; B01J 19/00; C01B 3/02

(52) U.S. Cl. 48/62 R; 48/197 R; 422/170; 252/373

(57) ABSTRACT

This invention relates to processes and apparatuses for reducing pollutants and/or producing syngas. The process includes the step of reacting a first stream with at least one sulfur compound to form a second stream with carbon dioxide, hydrogen sulfide, and a reduced amount of the at least one sulfur compound, and the step of recovering elemental sulfur from a portion of the second stream to form a third steam with the at least one sulfur compound, carbon dioxide, and a reduced amount of hydrogen sulfide. The process includes the step of directing at least a portion of the third stream to form a portion of the first stream.

### BACKGROUND

1. Technical Field

This invention relates to processes and apparatuses for reducing pollutants and/or producing syngas.

2. Discussion of Related Art

Issues of greenhouse gas levels and climate change have led to development of technologies seeking to reduce and/or eliminate carbon emissions to the atmosphere. As these technologies advance, various techniques to convert feedstocks into electricity have been developed. However, even with the above advances in technology, there remains a need and a desire to reduce pollutants and/or produce syngas.

### SUMMARY

This invention relates to processes and apparatuses for reducing pollutants and/or producing syngas. Recycling at least a portion of a pollutant containing stream can allow for destruction of the pollutant, such as by a water gas shift reaction. The processes and apparatuses of this invention can among other things reduce pollutant emissions, increase sulfur recovery, increase carbon capture percentages, while in the process of producing syngas. Recycling pollutants, such as carbonyl sulfide to a shift converter may require less energy for destruction and offer process simplification versus returning the pollutants to a gasifier and/or reformer inlet. Similarly, recycling pollutants to the shift converter can destroy the pollutant, rather than merely circulating in an acid gas removal unit as occurs with a recycle to the acid gas removal unit.

According to a first embodiment, this invention includes a process for reducing pollutants. The process includes the step of reacting a first stream with at least one sulfur compound to form a second stream with carbon dioxide, hydrogen sulfide, and a reduced amount of the at least one sulfur compound, and the step of recovering elemental sulfur from a portion of the second stream to form a third steam with the at least one sulfur compound, carbon dioxide, and a reduced amount of hydrogen sulfide. The process includes the step of directing at least a portion of the third stream to form at least a portion of the first stream.

According to a second embodiment, this invention includes a process of producing clean syngas. The process includes the step of reacting a feedstock stream in a reactor unit to form a reactor unit effluent stream, and the step of converting the reactor unit effluent stream in a shift conversion unit to form a shift conversion unit effluent stream. The process includes the step of separating the shift conversion unit effluent stream in an acid gas removal unit to form a hydrogen stream, a hydrogen sulfide acid gas stream, and a carbon dioxide stream, and the step of recovering elemental sulfur from the hydrogen sulfide acid gas stream in a sulfur recovery unit to form a sulfur stream and a sulfur recovery unit effluent tail gas stream. The process includes the step of connecting the sulfur recovery unit effluent tail gas stream to the shift conversion unit.

According to a third embodiment, this invention includes an apparatus for reducing pollutants. The apparatus includes a sulfur recovery unit effluent tail gas stream, and a shift conversion unit connected to the sulfur recovery unit effluent tail gas stream. The apparatus includes a shift conversion unit effluent stream connected to the shift conversion unit, and an acid gas removal unit connected to the shift conversion unit effluent stream. The apparatus includes a hydrogen stream connected to the acid gas removal unit, and optionally a carbon dioxide stream connected to the acid gas removal unit. The apparatus includes a hydrogen sulfide stream connected to the acid gas removal unit, and a sulfur recovery unit connected to the hydrogen sulfide stream and the sulfur recovery unit effluent tail gas stream. The apparatus includes a sulfur stream connected to the sulfur recovery unit.

According to a fourth embodiment, this invention includes an apparatus for producing syngas. The apparatus includes a feedstock stream and a reactor unit connected to the feedstock stream. The apparatus includes a reactor unit effluent stream connected to the reactor unit, and a shift conversion unit connected to the reactor unit effluent stream. The shift conversion unit includes of one or more shift conversion devices. The apparatus includes a shift conversion unit effluent stream connected to the shift conversion unit, and an acid gas removal unit connected to the shift conversion unit effluent stream. The apparatus includes a hydrogen stream connected to the acid gas removal unit, and a hydrogen sulfide stream connected to the acid gas removal unit. The apparatus includes a carbon dioxide stream connected to the acid gas removal unit, and a sulfur recovery unit connected to the hydrogen sulfide stream. The apparatus includes a sulfur stream connected to the sulfur recovery unit, and a sulfur recovery unit effluent tail gas stream connected to the sulfur recovery unit and the shift conversion unit.

### BRIEF DESCRIPTION OF THE DRAWING

The accompanying drawings, which are incorporated in and constitute a part of this specification, illustrate embodiments of the invention and, together with the description, serve to explain the features, advantages, and principles of the invention. In the drawings:

FIG. 1 schematically shows an apparatus for reducing pollutants, according to one embodiment;

FIG. 2 schematically shows an apparatus for reducing pollutants, according to one embodiment;

FIG. 3 schematically shows an apparatus for reducing pollutants, according to one embodiment;

FIG. 4 schematically shows an apparatus for reducing pollutants, according to one embodiment;

FIG. 5 schematically shows an apparatus for reducing pollutants, according to one embodiment;

FIG. 6 schematically shows a shift conversion unit, according to one embodiment;

FIG. 7 schematically shows an apparatus for reducing pollutants, according to one embodiment;

FIG. 8 schematically shows a reactor unit, according to one embodiment;

FIG. 9 schematically shows an acid gas removal unit, according to one embodiment;

FIG. 10 schematically shows an acid gas removal unit, according to one embodiment;

FIG. 11 schematically shows an apparatus for producing syngas, according to one embodiment;

FIG. 12 schematically shows a hydrogenation unit, according to one embodiment;

FIG. 13 schematically shows a shift conversion unit, according to one embodiment;

FIG. 14 schematically shows a tail gas treatment unit, according to one embodiment;

FIG. 15 schematically shows a reactor unit, according to one embodiment;

FIG. 16 schematically shows an acid gas removal unit, according to one embodiment; and

FIG. 17 schematically shows an acid gas removal unit, according to one embodiment.

### DETAILED DESCRIPTION

This invention relates to processes and apparatuses for reducing pollutants and/or producing syngas. According to one embodiment, this invention may include destruction of carbonyl sulfide by recycle of a sulfur recovery unit effluent or tail gas treatment unit tail gas to a shift reactor. Remaining carbonyl sulfide in a sulfur recovery unit effluent and/or tail gas treatment unit effluent can be removed by recycling a gas stream to a shift conversion unit in the process block of an integrated gasification combined cycle with carbon capture power plant. A carbonyl sulfide stream can convert to hydrogen sulfide and carbon dioxide by a water gas shift reaction in a shift conversion bed. Tail gas from the sulfur recovery unit may be hydrogenated, quenched, and then recycled back to the shift reactor. In the alternative, tail gas from a tail gas treatment unit amine absorber overheard can be recycled back to the shift reactor. The second configuration may increase sulfur yields, such as for additional product sales and/or environmental compliance. The recycle stream can be routed to one or more shift converters of decreasing temperature.

This invention may also include a low pressure hydrogen sulfide absorber at an exit of a quench column off a sulfur recovery hydrogenation unit for hydrogen sulfide absorption from product gases. Any suitable solvent may be used, such as amines, modified amines, hindered amines, promoted amines, and/or the like.

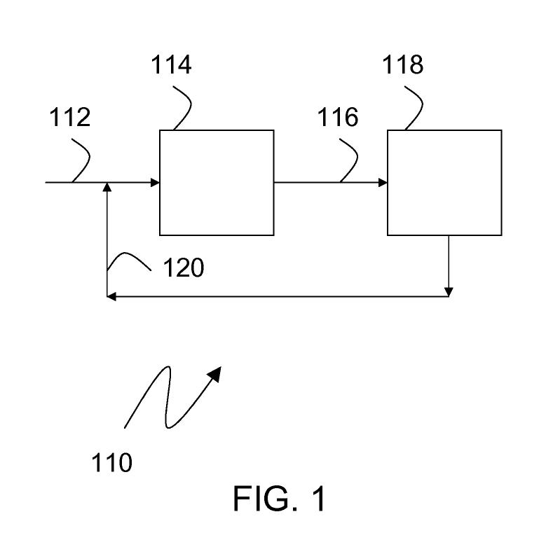

FIG. 1 schematically shows an apparatus 110 for reducing pollutants, according to one embodiment. The apparatus 110 includes a first stream 112 connected to a shift conversion unit 114 with a second stream 116. The shift conversion unit effluent stream or second stream 116 connects to a sulfur removal and/or recovery unit 118 with a third stream 120. The third stream 120 connects and/or recycles back to form at least a portion of the first stream 112.

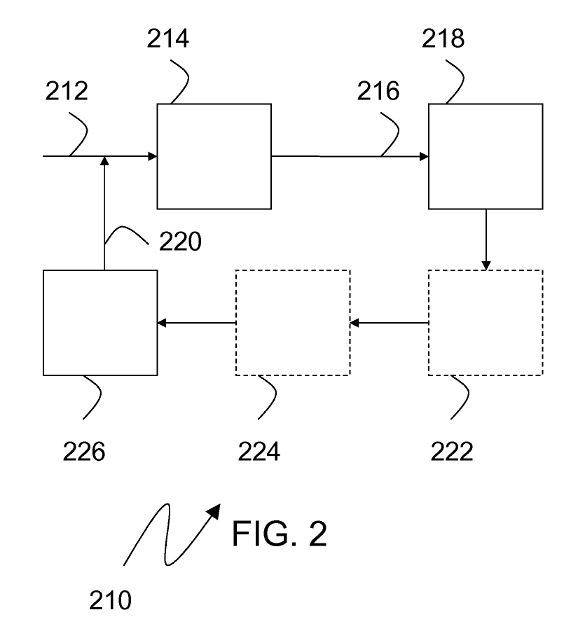

FIG. 2 schematically shows an apparatus 210 for reducing pollutants, according to one embodiment. The description of the apparatus 210 proceeds in accordance with the description of the apparatus 110 in FIG. 1 with changes made to the leading digit of the corresponding reference numerals. The apparatus 210 in FIG. 2 also differs from the apparatus 110 in FIG. 1 in that the apparatus 210 includes optionally a residual free oxygen removal unit 222, optionally a drying unit 224, and a compression unit 226, each on the third stream 220.

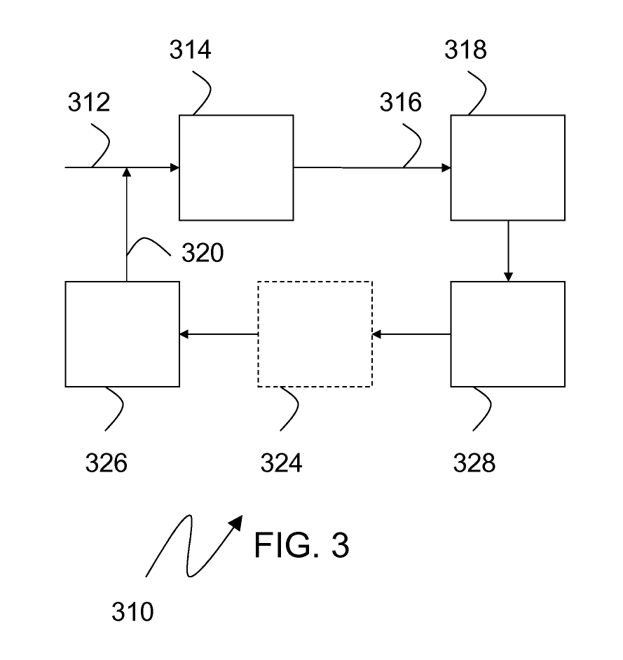

FIG. 3 schematically shows an apparatus 310 for reducing pollutants, according to one embodiment. The description of the apparatus 310 proceeds in accordance with the description of the apparatus 110 in FIG. 1 with changes made to the leading digit of the corresponding reference numerals. The apparatus 310 in FIG. 3 also differs from the apparatus 110 in FIG. 1 in that the apparatus 310 includes optionally a drying unit 324, a compression unit 326, and a hydrogenation unit 328, each on the third stream 320.

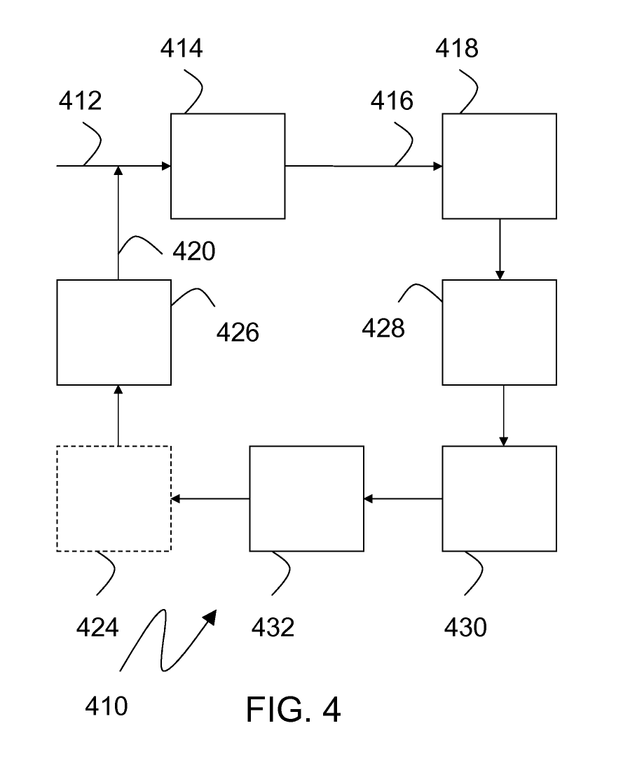

FIG. 4 schematically shows an apparatus 410 for reducing pollutants, according to one embodiment. The description of the apparatus 410 proceeds in accordance with the description of the apparatus 110 in FIG. 1 with changes made to the leading digit of the corresponding reference numerals. The apparatus 410 in FIG. 4 also differs from the apparatus 110 in FIG. 1 in that the apparatus 410 includes optionally a drying unit 424, a compression unit 426, a hydrogenation unit 428, a washing unit 430, and cooling unit 432, each on the on the third stream 420. The cooling unit can be before or after the washing unit.

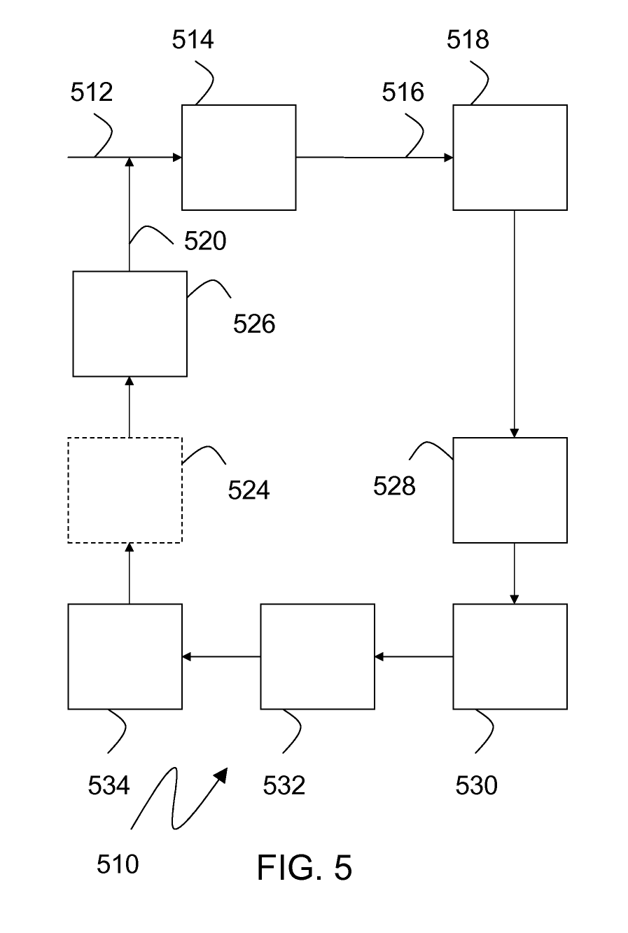

FIG. 5 schematically shows an apparatus 510 for reducing pollutants, according to one embodiment. The description of the apparatus 510 proceeds in accordance with the description of the apparatus 110 in FIG. 1 with changes made to the leading digit of the corresponding reference numerals. The apparatus 510 in FIG. 5 also differs from the apparatus 110 in FIG. 1 in that the apparatus 510 includes optionally a drying unit 524, a compression unit 526, a hydrogenation unit 528, a washing unit 530, cooling unit 532, and a tail gas treatment unit 534, each on the third stream 520.

Regarding the figures, the order of the units as depicted and/or described may operate in sequence. In the alternative, different orders and arrangements of the equipment combinations beyond those depicted and/or described are within the scope of this invention.

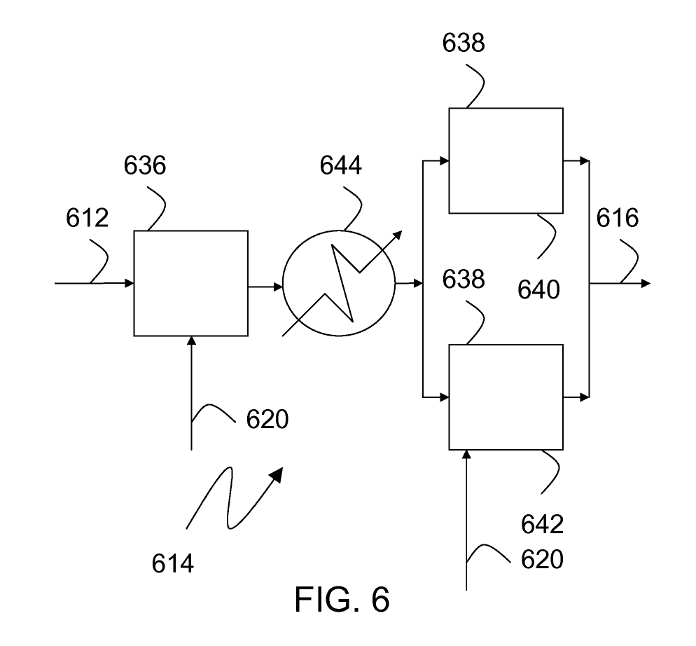

FIG. 6 schematically shows a shift conversion unit 614, according to one embodiment. A first stream 612 connects to the shift conversion unit 614 with one or more shift converters of decreasing temperature, such as a high temperature shift converter 636 and a low temperature shift converter 638 with a heat exchanger 664 between the converters, such as for heat removal and/or cooling. Desirably, cooling favors equilibrium conversion of the water gas shift reaction. The shift conversion unit 614 may include a first low temperature shift converter 640 and a second low temperature shift converter 642, such as in a suitable series and/or parallel configuration. Other configurations of one or more shift converters are within the scope of this invention. The first stream 612 converts into a second stream 616 by the first and second stage shift converters. At least a portion of the third stream 620 connects to one or more of the shift converters, such as a first shift converter. The second stream 616 optionally connects to a third stage (additional) shift converter (not shown) for further carbonyl sulfide (COS) conversion to form a subsequent stream (not shown).

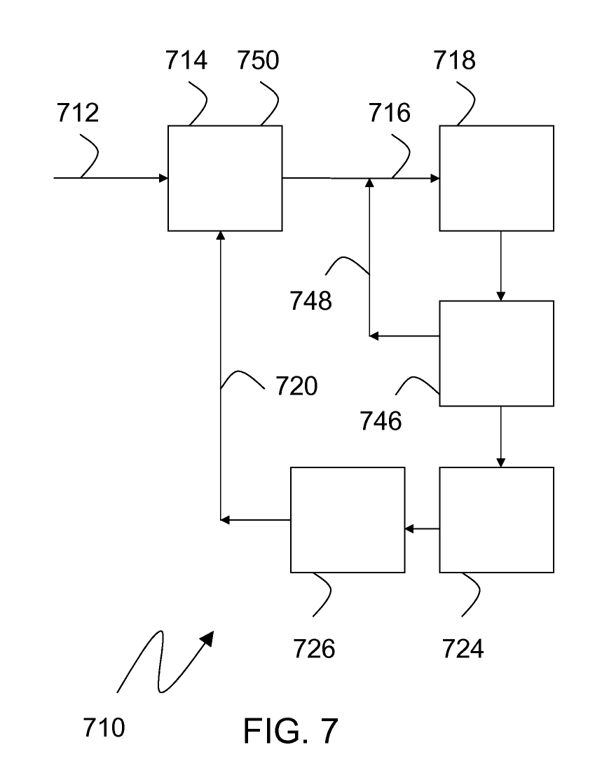

FIG. 7 schematically shows an apparatus 710 for reducing pollutants, according to one embodiment. The apparatus 710 has a first stream 712 connected to a shift Conversion unit 714 with a second stream 716. The second stream 716 connects to a sulfur recovery unit 718 with a third stream 720. A sulfur recovery unit and/or a tail gas treatment unit 746 separates a hydrogen sulfide stream 748 from the third stream 720. The hydrogen sulfide stream 748 returns and/or connects with the second stream, such as for recovery in the sulfur recovery unit 718. A drying unit 724 and a compression unit 726 process the third stream 720. The third stream 720 connects with one or more shift catalysts 750, such as within the shift conversion unit 714.

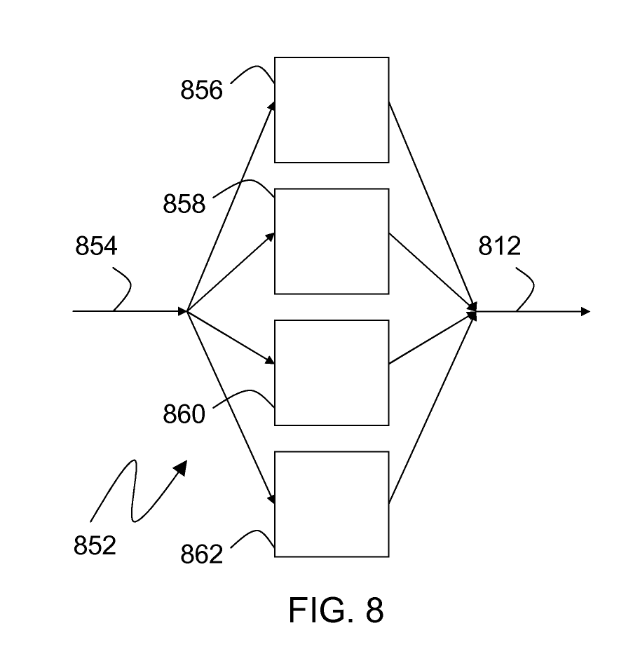

FIG. 8 schematically shows a reactor unit 852, according to one embodiment. The reactor unit 852 connects to a feedstock stream 854, such as a hydrocarbon material and/or a carbonaceous material. The reactor unit 852 includes at least one of a gasification unit 856, a reforming unit 858, partial oxidation unit 860, pyrolysis unit 862, and/or the like. The reactor unit 852 forms at least a portion of a first stream 812.

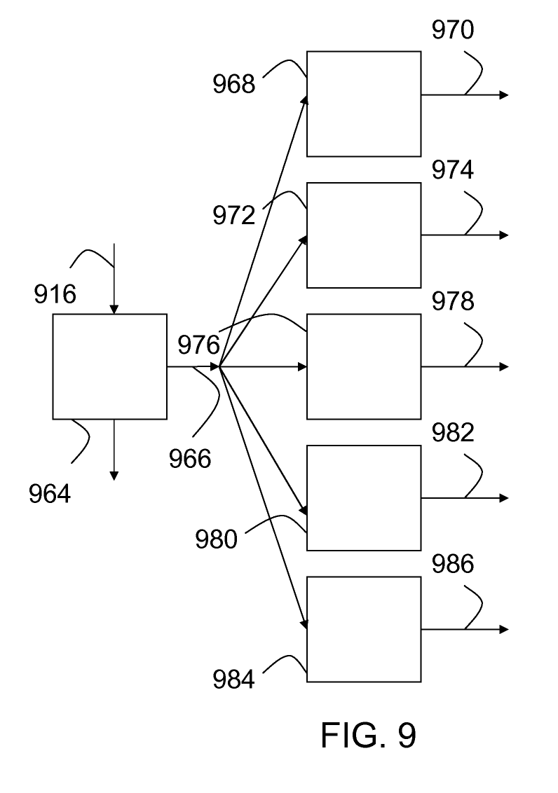

FIG. 9 schematically shows an acid gas removal unit 964, according to one embodiment. The acid gas removal unit 964 connects to-a second stream 916 to form a hydrogen stream 966. The hydrogen stream 966 connects to at least one of a steam generation unit 968 with a steam stream 970, an electricity generation unit 972 with an electricity stream 974, an ammonia generation unit 976 with an ammonia stream 978, a methanol generation unit 980 with a methanol stream 982, a synthetic hydrocarbon generation unit 984 with a synthetic hydrocarbon stream 986, and/or the like.

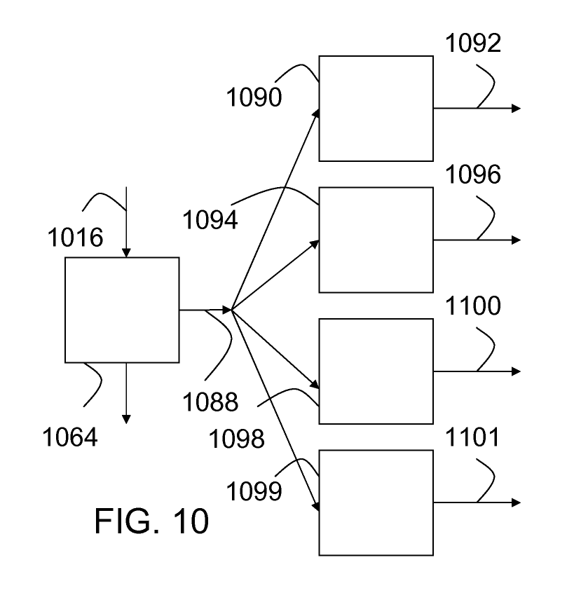

FIG. 10 schematically shows an acid gas removal unit 1064, according to one embodiment. The acid gas removal unit 1064 receives a second stream 1016 to form a carbon dioxide stream 1088. The carbon dioxide stream 1088 connects to at least one of a carbon sequestration unit 1090 with a carbon sequestration stream 1092, an enhanced oil recovery unit 1094, with an enhanced oil recovery stream 1096, an industrial gas supply unit 1098 with an industrial gas supply stream 1100, a chemical synthesis and production unit 1099 with a chemical stream 1101, and/or the like.

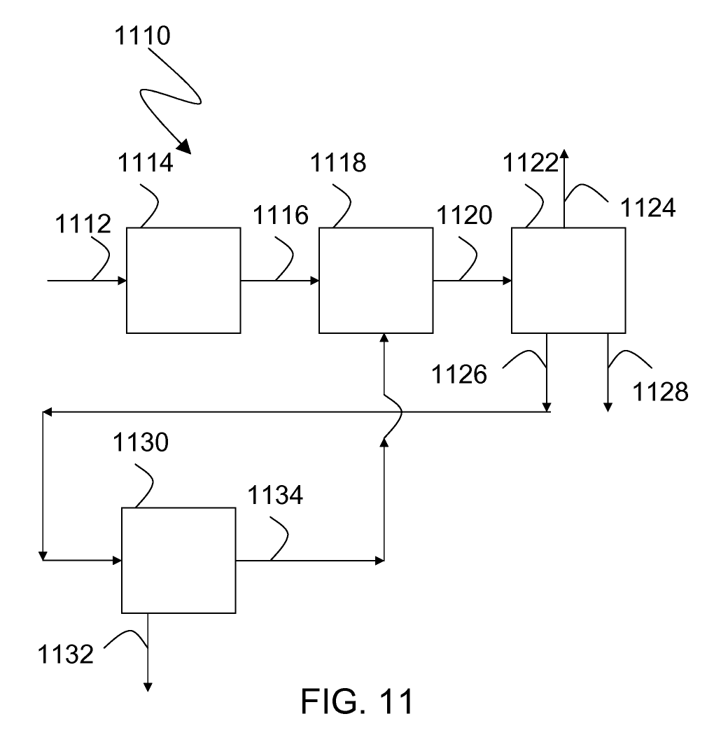

FIG. 11 schematically shows an apparatus 1110 for producing syngas, according to one embodiment. The apparatus 1110 includes a feedstock stream 1112 connected to a reactor unit 1114 with reactor unit effluent stream 1116. The reactor unit effluent stream 1116 connects to a shift conversion unit 1118 with a shift conversion effluent stream 1120. The shift conversion effluent stream 1120 connects to an acid gas removal unit 1122 with a hydrogen stream 1124, a, hydrogen sulfide acid gas stream 1126, and a carbon dioxide stream 1128. The hydrogen sulfide stream 1126 connects to a sulfur recovery unit 1130 with a sulfur stream 1132 and a sulfur recovery unit effluent tail gas stream 1134. The sulfur recovery unit tail gas stream 1134 connects to the shift conversion unit 1118, such as for destruction of carbonyl sulfide formed in the sulfur recovery unit. Destruction of carbonyl sulfide can reduce pollutant emissions, increase a carbon capture percentages from a power plant, increase an amount of sulfur product, and/or the like.

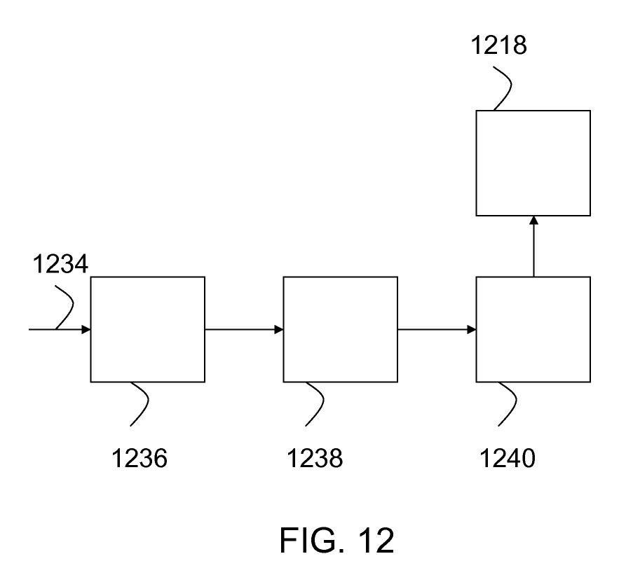

FIG. 12 schematically shows a hydrogenation unit 1236, according to one embodiment. The hydrogenation unit 1236 receives a sulfur recovery unit effluent tail gas stream 1234 and then supplies it to a washing unit 1238, a cooling unit 1240, and optionally a compression unit (not shown) before connecting to a shift conversion unit 1218.

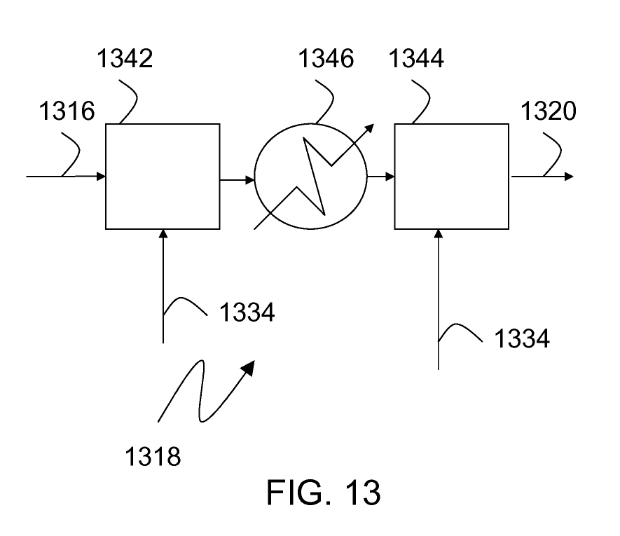

FIG. 13 schematically shows a shift conversion unit 1318, according to one embodiment. A reactor unit effluent stream 1316 connects to a high temperature shift converter 1342 followed by a medium temperature shift converter 1344 with one or more heat exchangers 1346 disposed between. The medium temperature shift converter 1344 is optionally followed by a third low temperature shift converter (not shown) with one or more heat exchangers (not shown) disposed between. The shift conversion unit 1318 forms a shift conversion effluent stream 1320 and a sulfur recovery unit effluent tail gas stream 1334 connects to one or more of the shift converters, such as for destruction of one or more pollutants.

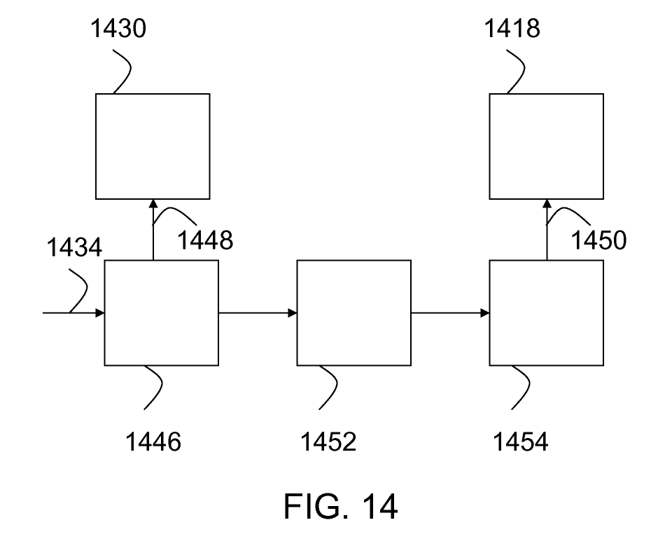

FIG. 14 schematically shows a tail gas treatment unit 1446, according to one embodiment. A sulfur recovery unit effluent tail gas stream 1434 connects to the tail gas treatment unit 1446 to form a second hydrogen sulfide stream 1448 and a tail gas treatment unit effluent stream 1450. The second hydrogen sulfide stream connects to a sulfur recovery unit 1430. The tail gas treatment unit effluent connects to a drying unit 1452 and a compression unit 1454 before connecting to a shift conversion unit 1418.

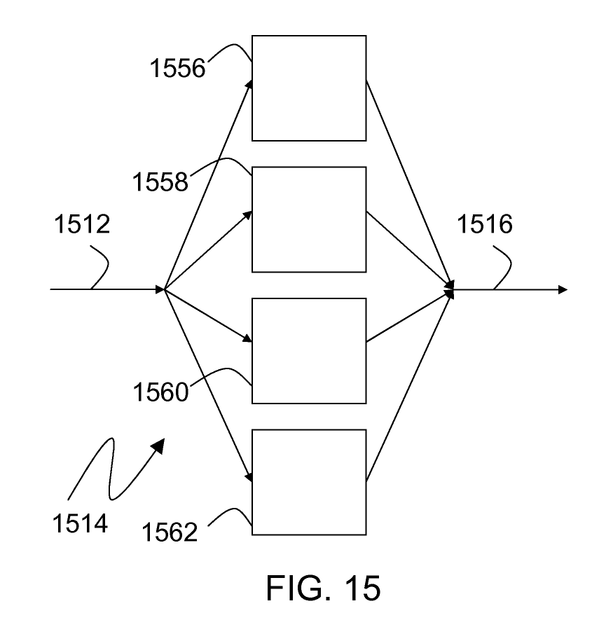

FIG. 15 schematically shows a reactor unit 1514, according to one embodiment. A feedstock stream 1512 connects to the reactor unit 1514 and forms a reactor unit effluent stream 1516. The reactor unit 1514 may include at least one of a reforming unit 1556, a gasification unit 1558, a partial oxidation unit 1560, a pyrolysis unit 1562, and/or the like.

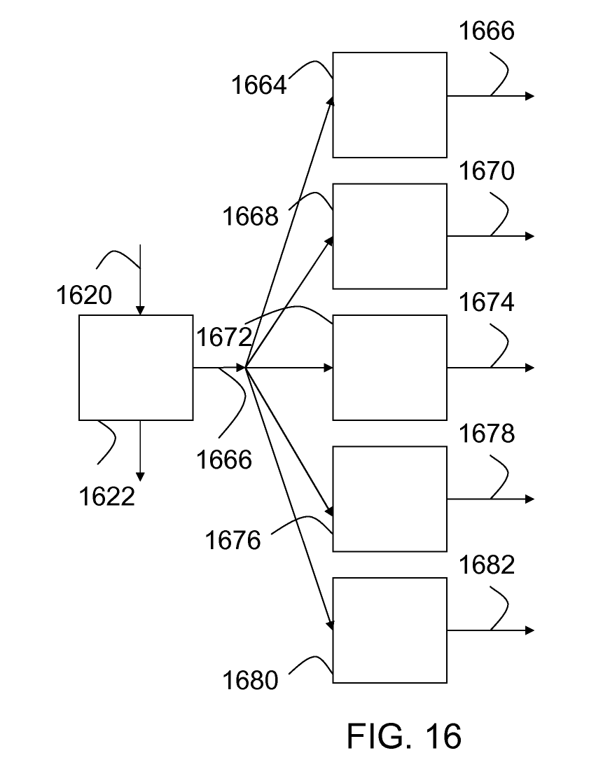

FIG. 16 schematically shows an acid gas removal unit 1622, according to one embodiment. A shift conversion effluent stream 1620 connects to the acid gas removal unit 1622 to form a hydrogen stream 1624. The hydrogen stream 1624 may be used in at least one of a steam generation unit 1664 with a steam stream 1666, an electricity generation unit 1668 with an electricity stream 1670, an ammonia generation unit 1672 with an ammonia stream 1674, a methanol generation unit 1676, with a methanol stream 1678, a synthetic hydrocarbon generation unit 1680 with a synthetic hydrocarbon stream 1682, and/or the like.

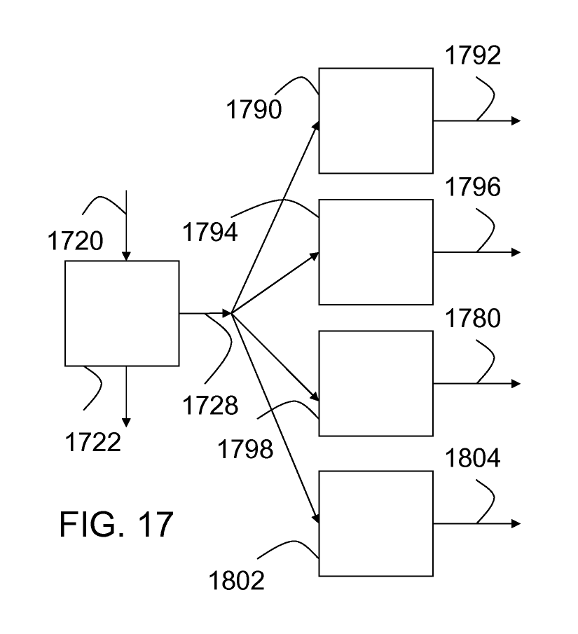

FIG. 17 schematically shows an acid gas removal unit 1722 according to one embodiment. A shift conversion effluent stream 1720 connects to the acid gas removal unit 1722 and forms a carbon dioxide stream 1728. The carbon dioxide stream 1728 connects to at least one of a carbon sequestration unit 1790 with a carbon sequestration stream 1792, an enhanced oil recovery unit 1794 with an enhanced oil recovery stream 1796, an industrial gas supply unit 1798 with a industrial gas supply stream 1800, a chemical synthesis and production unit 1802 with a chemical stream 1804, and/or the like.

According to one embodiment, the invention may include a process for reducing pollutants. The process may include the step of reacting a first stream with at least one sulfur compound to form a second stream with carbon dioxide, hydrogen sulfide, and a reduced amount of the at least one sulfur compound. The process may include the step of recovering elemental sulfur from a portion of the second stream to form a third steam with the at least one sulfur compound, carbon dioxide, and a reduced amount of hydrogen sulfide. The process may include the step of directing at least a portion of the third stream to form a portion of the first stream.

Process broadly refers to a proceeding, a series of events and/or steps, progress and/or the like, such as to accomplish a task, a goal, and/or an outcome. Processes may be batch, semi-batch, discrete, continuous, semi-continuous, and/or the like.

Reducing broadly refers to removing, lowering, and/or eliminating a substance and/or a material, such as a pollutant, a defilement, a contaminant, an imperfection, an undesirable element, and/or the like. Reducing may include any suitable amount and/or quantity lowered and/or removed, such as by at least about 10 percent, at least about 25 percent, at least about 50 percent, at least about 75 percent, at least about 90 percent, at least about 95 percent, at least about 99 percent, and/or the like of the contaminant from an incoming stream on a mass basis, a volume basis, a mole basis, and/or the like.

Stream broadly refers to a flow, a succession, a supply, and/or the like of a material, a substance, and/or the like.

Pollutant broadly refers to unwholesome and/or undesirable elements and/or materials, such as to corrupt, soil, infect, contaminate, defile, make impure, make inferior, make tainted, and/or the like. The pollutant may be in any suitable amount, such as between about zero percent and about 50 percent, between about 0.001 percent and about 20 percent, between about 0.01 percent and about 5 percent, and/or the like on a mass basis, a volume basis, a mole basis, and/or the like. According to one embodiment, the pollutant includes substances whose discharge into the environment can be regulated by state and/or federal agencies, such as hazardous pollutants controlled by the U.S. Environmental Protection Agency.

Form broadly refers to make up, constitute, develop, give shape, and/or the like.

According to one embodiment the pollutant may include one or more sulfur compounds, such as carbonyl sulfide, carbon disulfide, hydrogen sulfide, marcaptans, thiols, thiolates, thiophenes, sulfoxides, sulfones, other organic sulfur compounds, and/or the like. Sulfur compound broadly refers to any substance and/or material containing one or more atoms of sulfur in a compound and/or mixture.

Reacting broadly refers to any suitable transformation with at least a portion of a chemical step, such as synthesis, decomposition, single replacement, double replacement, and/or the like. Reactions may be exothermic, endothermic, and/or the like. Reactions may or may not utilize a catalyst, such as to increase a reaction rate. Catalysts may be homogenous, heterogeneous, supported, unsupported, and/or the like.

According to one embodiment, the step of reacting can include a water gas shift reaction, such as to convert carbon monoxide by consuming water molecules and producing hydrogen molecules. Desirably, at least a portion of the pollutant and/or the at least one sulfur compound may react under shift conversion conditions to form other compounds, such as hydrogen sulfide, carbon dioxide, and/or the like.

Converting broadly refers to changing from one thing and/or property into another, such as carbon monoxide into carbon dioxide.

At least one broadly refers to one or more of an item, an object, a thing, a step, and/or the like.

Compound broadly refers to a material and/or a substance formed by a union of elements and/or parts, such as by a chemical union of two or more ingredients in suitable proportions. Compounds may include ionic bonds, covalent bonds, van der Waals forces, other molecular forces, and/or the like.

Hydrogen sulfide broadly refers to a compound including one sulfur atom and two hydrogen atoms.

Carbon dioxide broadly refers to a compound including one carbon atom and two oxygen atoms.

Carbon monoxide broadly refers to a compound including one carbon atom and one oxygen atom.

Gas broadly refers to not being primarily in a solid state and/or a liquid state, such as having a generally indefinite volume (compressible) and/or a generally indefinite shape (fills its container). Gases may be primarily vapors but also may include solid or particulate matter and/or fine liquid droplets, such as to form a suspension and/or an aerosol.

The step of recovering elemental sulfur may include any suitable process and/or chemical reaction, such as such as converting hydrogen sulfide into molten elemental sulfur. Elemental broadly refers to relating to being primarily an element. Elemental states may include any suitable form, such as amorphous forms, crystalline forms, solid forms, liquid forms, and/or the like. Recovering sulfur in other forms and/or compounds is within the scope of this invention.

The sulfur process may include reactions used in a Claus unit, such as oxidation, decomposition, forming pollutants, and/or the like. The sulfur recovery process may include any suitable device and/or equipment, such as with one or more burners, one or more condensers, one or more catalyst beds, and/or the like. The step of recovering elemental sulfur may convert any suitable portion of hydrogen sulfide in a feed stream to elemental sulfur, such as at least about 50 percent, at least about 75 percent, at least about 85 percent, at least about 90 percent, at least about 95 percent, at least about 99 percent, and/or the like on a mass basis, a volume basis, a mole basis, and/or the like.

Unit broadly refers to a collection, a group, and/or an assembly of devices and/or equipment, such as to accomplish and/or perform a task and/or an outcome. Units may include any suitable process equipment, such as vessels, columns, pumps, valves, compressors, control systems, and/or the like.

Without being bound by theory, the step of recovering elemental sulfur may also form an amount of the pollutant and/or the at least one sulfur compound, such as carbonyl sulfide.

Directing broadly refers to point, extend, project, point out the way, and/or the like. The step of directing at least a portion of the third stream to form a portion of the first stream can have an effect of recycling and/or returning the third stream to an earlier point in the process, such as before the reacting step which can reduce and/or remove the one or more sulfur compounds made and/or formed in the recovering elemental sulfur step. The third stream may form any suitable amount and/or quantity of the first stream, such as between about 1 percent and about 100 percent, between about 5 percent and about 30 percent, and/or the like on a mass basis, a volume basis, a mole basis, and/or the like.

By recycling to an earlier point in the process, at least a portion of the one or more sulfur compounds can be converted to hydrogen sulfide which can be removed from the process in the recovering sulfur step instead of venting and/or releasing to the atmosphere and/or the environment.

At least a portion may refer to any suitable amount and/or valie, such as between about 0.01 percent and about 100 percent, at least about 10 percent, at least about 25 percent, at least about 50 percent, at least about 75 percent, at least about 90 percent, and/or the like on a mass basis, a volume basis, a mole basis, and/or the like.

According to one embodiment, the process may include the step of optionally removing free oxygen from at least a portion of the third stream, optionally the step of drying at least a portion of the third stream, and the step of compressing at least portion of the third stream.

Optionally broadly refers to being not compulsory and/or needed, such as with an act of choosing. Optionally may include periodic and/or cyclic operations in addition to continuous operations.

Removing free oxygen may include any suitable step and/or action to reduce at least a portion of free and/or excess oxygen contained within the third stream. Removing oxygen can be done with any suitable physical and/or chemical mechanism, such as reactions, sorption, and/or the like. Removing oxygen may use any suitable equipment and/or device, such as membranes, molecular sieves, oxygen scavengers, catalysts, and/or the like. Removing free oxygen may include lowering the outlet oxygen concentration to any suitable level, such as below about 1 percent, below about 0.1 percent, below about 1,000 parts per million, below about 100 parts per million, below about 10 parts par million, and/or the like on a mass basis, a volume basis, a mole basis, and/or the like. Removing free oxygen may occur and/or take place in any suitable device and/or equipment, such as an oxygen removal unit with membranes, chemical injection systems, and/or the like.

Drying broadly refers to reducing and/or removing at least a portion of a moisture content from a material and/or a substance. Drying may include reducing a dew point by any suitable amount, such as at least about 10 degrees Celsius, at least about 25 degrees Celsius, at least about 40 degrees Celsius, and/or the like. Drying may include reducing an outlet water content to any suitable level, such as below about saturation, below about 10 percent, below about 1 percent, below about 0.1 percent, below about 1,000 parts per million, below about 100 parts per million, below about 10 parts par million, and/or the like on a mass basis, a volume basis, a mole basis, and/or the like. Drying may occur and/or take place in any suitable drying device and/or equipment, such as a drying unit.

Compressing broadly refers to increasing a pressure, such as to squeeze and/or reduce a volume of a material and/or a substance. The step of compressing may include any suitable increase in pressure, such as such as at least about 1 bar absolute, at least about 3 bar absolute, at least about 5 bar absolute, at least about 10 bar absolute, at least about 65 bar absolute, at least about 100 bar absolute, and/or the like. The step of compressing may use any suitable equipment and/or device, such as a compression unit with centrifugal compressors, screw compressors, positive displacement compressors, reciprocating compressors, and/or the like. The compressors may include one or more stages operating in series and/or parallel configurations. The compressing step may liquefy at least a portion of a stream. The compressing step may solidify at least a portion of a stream. The compressing step may form a supercritical fluid (above the critical point). The compressing step may provide a motive force, such as to return at least a portion of the third stream to an earlier (higher pressure) point in the process.

According to one embodiment, the process may include the step of hydrogenating at least a portion of the third stream, the step of optionally drying at least a portion of the third stream, and the step of compressing at least portion of the third stream.

Hydrogenation broadly refers to any suitable chemical process to add hydrogen to a compound and/or a substance, such as to reduce and/or saturate the material and/or the substance. Hydrogenation may include full and/or complete hydrogenation, such as all oxygen atoms are removed from hydrocarbons to form water. Hydrogenation may include partial and/or mild hydrogenation, such as to react only a suitable portion of the possible sites and/or atoms. Hydrogenation may use a catalyst. Hydrogenation may sometimes be referred to as methanation, such as where carbon dioxide with hydrogen converts to methane and water. Hydrogenation may occur and/or take place in any suitable device and/or equipment, such as a hydrogenation unit. Hydrogenation may occur and/or take place in any suitable location and/or stage in the process, such as after the sulfur recovery unit to convert sulfur compounds to hydrogen sulfide.

According to one embodiment, the process may include the step of hydrogenating at least a portion of the third stream, the step of washing at least portion of the third stream, the step of cooling at least portion of the third stream, optionally the step of drying at least a portion of the third stream, and the step of compressing at least a portion of the third stream.

Washing broadly refers to contacting with a suitable wash media and/or solution, such as water, solvent, salt solution, amine, and/or the like. Washing may remove any suitable amount of an impurity, such as at least about at least about 10 percent, at least about 25 percent, at least about 50 percent, at least about 75 percent, at least about 90 percent, at least about 95 percent, at least about 99 percent, and/or the like of the impurity from an incoming stream on a mass basis, a volume basis, a mole basis, and/or the like. Washing may use any suitable device and/or equipment, such as a washing unit with contacting equipment, trays, packing demisters, spray nozzles, columns, and/or the like. Washing may increase a water content in a stream, such as to a saturation level and/or the like.

Cooling broadly refers to lowering and/or dropping a temperature and/or internal energy of a substance, such as by any suitable amount. Cooling may include a temperature drop of at least about 1 degree Celsius, at least about 5 degrees Celsius, at least about 10 degrees Celsius, at least about 15 degrees Celsius, at least about 25 degrees Celsius, at least about 50 degrees Celsius, at least about 100 degrees Celsius, at least about 200 degrees Celsius, at least about 500 degrees Celsius, and/or the like. The cooling may use any suitable heat sink, such as steam generation, hot water heating, cooling water, air, refrigerant, other process streams (integration), and/or the like. One or more sources of cooling may be combined and/or cascaded to reach a desired outlet temperature.

The cooling step may use a cooling unit with any suitable device and/or equipment. According to one embodiment, cooling may include indirect heat exchange, such as with one or more heat exchangers. Heat exchangers may include any suitable design, such as shell and tube, plate and frame, counter current, concurrent, extended surface, and/or the like. In the alternative, the cooling may use evaporative (heat of vaporization) cooling and/or direct heat exchange, such as a liquid sprayed directly into a process stream.

According to one embodiment, the process may include the step of hydrogenating at least a portion of the third stream, the step of washing at least a portion of the third stream, the step of cooling at least a portion of the third stream, optionally the step of drying at least a portion of the third stream, the step of compressing at least a portion of the third stream, and the step of treating at least a portion of the third stream in a tail gas treatment unit.

Treating broadly refers to any suitable action to act upon and/or improve a substance and/or material. Treating may include reducing an amount and/or quantity of sulfur in a stream, such as following and/or subsequent to a sulfur recovery step.

Tail gas broadly refers to an exit stream and/or an exhaust from a unit and/or device. The tail gas may be at any suitable temperature and/or pressure. The tail gas may be vented to atmosphere, used in subsequent processing, used in subsequent pollution control devices, used in subsequent heat recovery, used in subsequent power recovery, and/or the like.

The tail gas treatment unit may include any suitable devices and/or equipment, such as a burner, a catalyst bed, an ammonia scrubber, a brine treatment device, an amine contactor, a wash column, a regeneration column, and/or the like. The tail gas treatment unit can reduce sulfur oxides, convert of sulfur oxides to elemental sulfur, and/or the like.

According to one embodiment, the reacting occurs with one or more catalysts of decreasing temperature, and the third stream connects to one or more of the one or more catalysts. The catalysts may be arranged in any suitable configuration, such as one or more series and/or parallel arrangements. The configurations may include cooling in between one or more stages and/or reactors. The reacting may use any suitable equipment and/or devices, such as one or more shift conversion units. The shift conversion units may include high temperature shift converters, medium temperature shift converters, low temperature shift converters, and/or the like. The shift converters may include any suitable catalysts, such as sweet shift catalyst, sour shift catalyst, and/or the like. The shift conversion unit may include any suitable number of stages, such as at least about 1, at least about 2, at least about 3, at least about 4, and/or the like.

Connect broadly refers to join and/or establish communication, such as fluid communication. Fluid communication may be established by any suitable manner, such as pipes, tubing, conduits, channels, flow paths, placing in proximity, and/or the like. Connecting may include any suitable motive force devices, such as to move a substance and/or a material from one location to another. Motive force devices may include pumps, compressors, blowers, ejectors, eductors, conveyors, and/or the like.

According to one embodiment, the process may include the step of separating a hydrogen sulfide stream from a portion of the third stream, the step of directing at least a portion of the hydrogen sulfide stream to combine with at least a portion of the second stream, the step of drying at least a portion of the third stream, the step of compressing at least a portion of the third stream, and the step of directing at least a portion of the third stream to one or more catalysts.

Separating a hydrogen sulfide steam may use any suitable technique, such as solvent extraction, amine contacting, and/or the like. The hydrogen sulfide stream may come from and/or originate in a tail gas treatment unit and recycle back to a sulfur recovery unit influent stream, such as to increase a total efficiency of sulfur removal.

The step of directing at least a portion of the third stream to one or more catalysts may allow for destruction of the one or more sulfur compounds, such as carbonyl sulfide to hydrogen sulfide, carbon dioxide, carbon monoxide, and/or the like.

According to one embodiment, the process may include the step of reacting a feedstock stream to form at least a portion of the first stream. The reacting may include any suitable reaction, such as at least one of gasification, reforming, steam methane reforming, oxidation, partial oxidation, pyrolysis, coking, cracking, catalytic cracking, thermal cracking, and/or the like. The step of reacting may include any suitable equipment and/or devices, such as furnaces, reformers, combustors, gasifiers, cokers, fixed beds, fluidized beds, slurry beds, risers, downers, regenerators, heat exchangers, quenches, pressure vessels, pipes, valves, pumps, compressors, control systems, and/or the like. The reacting may take place and/or occur in any suitable reactor unit, such as one or more of a gasification unit, a reforming unit, a steam methane reforming unit, a partial oxidation unit, a pyrolysis unit, a coking unit, a coking unit, and/or the like. The reactor unit may convert any suitable amount of the feedstock stream into hydrogen and/or syngas.

Feedstock broadly refers to any suitable material and/or substance for consumption, reaction, conversion, processing, and/or the like. According to one embodiment, the feedstock may include carbonaceous materials, such as coal, peat, coke, petroleum coke, bitumen, crude oil, tar sands, fossil fuels, biomass, biomass char, and/or the like. Desirably, but not necessarily, at least a portion of the feedstock may originate and/or be supplied from renewable resources, such as non-fossil fuels.

Biomass broadly refers to plant and/or animal materials and/or substances derived at least in part from living substances, such as lignocellulosic sources. Lignocellulosic broadly refers to containing cellulose, hemicellulose, lignin, and/or the like, such as plant material. Lignocellulosic material may include any suitable material, such as sugar cane, sugar cane bagasse, energy cane, energy cane bagasse, rice, rice straw, corn, corn stover, wheat, wheat straw, maize, maize stover, sorghum, sorghum stover, sweet sorghum, sweet sorghum stover, cotton, cotton remnant, sugar beet, sugar beet pulp, soybean, rapeseed, jatropha, switchgrass, miscanthus, other grasses, algae, fungi, bacteria, timber, softwood, hardwood, wood bark; wood waste, sawdust, paper, paper waste, agricultural waste, manure, dung, sewage, municipal solid waste, any other suitable biomass material, and/or the like.

According to one embodiment, the step of reacting produces at least some amount and/or quantity of hydrogen and/or syngas. Syngas broadly refers to a mixture of gases derived at least in part from synthetic steps and/or actions. The syngas may include any suitable composition, such as primarily hydrogen with some amount of carbon oxides (carbon monoxide and/or carbon dioxide) and/or other contaminants. The syngas may have any suitable energy content, such as high value syngas with an energy content greater than methane on a volumetric basis, syngas with an energy content about equal to methane on a volumetric basis, low value syngas with an energy content less than methane on a volumetric basis, and/or the like.

According to one embodiment, the process includes the step of separating a hydrogen stream from a portion of the second stream, and the step of using at least a portion of the hydrogen stream to produce at least one of steam, electricity, ammonia, methanol, synthetic hydrocarbon products, and/or the like.

Separating a hydrogen steam may use any suitable technique, such as solvent extraction, distillation, cryogenic separation, membrane separation, pressure swing absorption, temperature swing absorption, and/or the like. According to one embodiment, the separating may occur in an acid gas removal unit.

Acid gas removal unit broadly refers to any suitable device and/or equipment to separate at least a portion of an acid gas stream from another process stream, such as a hydrogen stream. Acid gas broadly refers to a gas and/or vapor that contains hydrogen sulfide, carbon dioxide, other similar contaminants, and/or the like. Desirably, the acid gas removal unit can separate and/or form a hydrogen stream or a purified syngas stream, and an acid gas stream. The acid gas removal unit may also separate the acid gas stream into one or more components and/or constituents, such as into a carbon dioxide stream and a hydrogen sulfide stream.

The acid gas removal unit may include any suitable device and/or equipment, such as pumps, valves, pipes, compressors, heat exchangers, pressure vessels, distillation columns, control systems, and/or the like. According to one embodiment, the acid gas removal unit includes one or more absorber towers and one or more stripper towers. The acid gas removal unit may recover and/or separate any suitable amount of acid gas from a process stream, such as at least about 50 percent, at least about 75 percent, at least about 85 percent, at least about 90 percent, at least about 95 percent, at least about 99 percent, and/or the like on a mass basis, a volume basis, a mole basis, and/or the like.

The acid gas removal unit may include Rectisol systems from Linde AG, Munich, Germany, and/or Lurgi GmbH, Frankfurt, Germany, methanol systems, alcohol systems, amine systems, promoted amine systems, hindered amine systems, glycol systems, ether systems, potassium carbonate systems, water scrubbing systems, other suitable solvents, and/or the like.

Solvent broadly refers to a substance and/or material capable at least in part of dissolving and/or dispersing one or more other materials and/or substances, such as to provide and/or form a solution. The solvent may be polar, nonpolar, neutral, protic, aprotic, and/or the like. The solvent may include any suitable element, molecule, and/or compound, such as methanol, ethanol, propanol, glycols, ethers, ketones, other alcohols, amines, salt solutions, and/or the like. The solvent may include physical solvents, chemical solvents, and/or the like. The solvent may operate by any suitable mechanism, such as physical absorption, chemical absorption, chemisorption, physisorption, adsorption, pressure swing adsorption, temperature swing adsorption, and/or the like.

According to one embodiment, a solvent stream of the acid gas removal unit includes primarily methanol. The solvent stream may be at any suitable pressure and/or temperature.

Use broadly refers to put into action or service, to carry out a purpose, and/or the like.

The hydrogen stream may be used for any suitable purpose, such as one or more of sold for industrial gas supply, sold for fuel, used to produce steam, used to produce electricity, used to produce ammonia, used to produce methanol, used to produce synthetic hydrocarbon products, and/or the like.

Synthetic hydrocarbon products broadly refer to compounds made by gas to liquids techniques and/or the like, such as Fischer-Tropsch processes, methanol to olefins, and/or the like. Synthetic hydrocarbons may include straight chain molecules, branched molecules, saturated molecules, unsaturated molecules, cyclic molecules, aromatic molecules, and/or the like. The synthetic hydrocarbons may include any other suitable functionality, such as ethers, alcohols, ketones, and/or the like. The synthetic hydrocarbons may be suitable for fuel usage, such as gasoline, gasoline blending stock, diesel, diesel blending stock, aviation fuel, aviation fuel blending stock, heating oil, heating oil blending stock, other transportation fuels, and/or the like. In the alternative, the synthetic hydrocarbons may be suitable for other applications and/or uses, such as chemical feedstocks, chemical products, solvents, coatings, surfactants, adhesives, copolymers, fertilizers, pharmaceuticals, and/or the like. According to one embodiment, the methanol may supply at least of portion of the methanol used in the acid gas removal unit.

The use of hydrogen may include any suitable equipment and/or device, such as one or more of a steam generation unit, an electricity generation unit, an ammonia generation unit, a methanol generation unit, a synthetic hydrocarbon product generation unit, and/or the like. Generation broadly refers to producing, making, manufacturing, and/or the like. The generation units may use and/or consume at least a portion of the hydrogen stream.

The steam generation unit may include any suitable device and/or equipment, such as boilers, heat exchangers, steam generators, turbines, condensers, and/or the like. The electricity generation unit may include any suitable device and/or equipment, such as generators, transformers, and/or the like. The ammonia generation unit may include any suitable device and/or equipment, such as compressors, converters, refrigeration systems, and/or the like. The methanol generation unit may include any suitable device and/or equipment, such as compressors, converters, refrigeration systems, and/or the like. The synthetic hydrocarbon generation unit may include any suitable device and/or equipment, such as compressors, reactors, and/or the like.

According to one embodiment, the process includes the step of separating a carbon dioxide stream from a portion of the second stream, and the step of using at least a portion of the carbon dioxide stream for one or more of carbon sequestration, enhanced oil recovery, industrial gas supply, chemical synthesis and production, and/or the like. The separating of the carbon dioxide stream may include any suitable equipment and/or device, such as the acid gas removal unit described above, and/or the like.

Carbon sequestration broadly refers to long term storage of carbon dioxide and/or other forms of carbon, such as by use of geoengineering techniques to deposit carbon into the ocean, on the land surface, and/or the like. Carbon sequestration may also include aspects of carbon capture and storage, such as injection into geologic formations. The carbon sequestration may use any suitable device and/or equipment, such as a carbon sequestration unit with compressors, pumps, and/or the like.

Enhanced oil recovery broadly refers to techniques and/or strategies to increase an amount of hydrocarbon recovered and/or removed from a geological structure. Enhanced oil recovery may include gas injection, chemical injection, ultrasonic stimulation, microbial injection, thermal recovery, and/or the like. Enhanced oil recovery may increase an amount of crude oil, natural gas, bitumen, coal, and/or the like. The enhanced oil recovery may use any suitable device and/or equipment, such as an enhanced oil recovery unit with compressors, pumps, and/or the like.

Industrial gas supply broadly includes uses and gases for commercial purposes and/or applications, such as refrigeration, food preservation, food preparation, beverage preparation, medical usage, chemical processes, biological processes, refrigeration, metallurgical processes, and/or the like. The industrial gas supply may use any suitable device and/or equipment, such as an industrial gas supply unit with compressors, pumps, and/or the like.

Chemical synthesis and production broadly includes materials and/or compounds derived at least in part from the streams of the processes and/or apparatuses, such as the greenhouse gas stream and/or carbon dioxide stream. The chemical synthesis and production may use any suitable device and/or equipment, such as a chemical synthesis and production unit compressors, reactors, pumps, and/or the like. According to one embodiment, the chemicals may include urea, carbonic acid, other fertilizers, and/or the like.

According to one embodiment, the invention may include a process of producing clean syngas. Clean syngas broadly refers to having at least a portion of non-hydrogen materials removed from a stream, such as carbon dioxide, hydrogen sulfide, and/or the like. The process may include the step of reacting a feedstock stream in a reactor unit to form a reactor unit effluent stream, and the step of converting the reactor unit effluent stream in a shift conversion unit to form a shift conversion unit effluent stream. The process may include the step of separating the shift conversion unit effluent stream in an acid gas removal unit to form a hydrogen stream, a hydrogen sulfide acid gas stream, and a carbon dioxide stream, and the step of recovering elemental sulfur from the hydrogen sulfide acid gas stream in a sulfur recovery unit to form a sulfur stream and a sulfur recovery unit effluent tail gas stream. The process may include the step of connecting the sulfur recovery unit effluent tail gas stream to the shift conversion unit.

Effluent broadly refers to flowing out of, leaving and/or exiting.

According to one embodiment, the process may include the step of hydrogenating the sulfur recovery unit effluent tail gas stream, the step of washing the sulfur recovery unit effluent tail gas stream, the step of cooling the sulfur recovery unit effluent tail gas stream, optionally the step of drying the sulfur recovery unit effluent tail gas stream, and the step of compressing the sulfur recovery unit effluent tail gas stream.

The shift conversion unit may include any suitable devices and/or equipment, such as one or more shift converters of decreasing temperature. Desirably, the sulfur recovery unit effluent tail gas stream connects to one or more of the one or more shift converters, such as the sulfur recovery unit effluent tail gas stream connects to a first shift converter.

The process may also include the step of separating a second hydrogen sulfide stream from the sulfur recovery unit effluent tail gas stream in a tail gas treatment unit, and the step of connecting the second hydrogen sulfide stream back to the sulfur recovery unit.

The separating the hydrogen sulfide stream may occur in an acid gas removal unit, as described above, for example.

According to one embodiment, the reactor unit may include at least one of a gasification unit, a reforming unit, a partial oxidation unit, a pyrolysis unit, and/or the like.

The hydrogen stream may be used for any suitable purpose, such as using the hydrogen stream to produce steam, electricity, ammonia, methanol, synthetic hydrocarbon products, and/or the like.

The carbon dioxide stream may be used for any suitable purpose, such as using the carbon dioxide stream for carbon sequestration, enhanced oil recovery, industrial gas supply, chemical synthesis and production, and/or the like.

The process may include where the step of converting the reactor unit effluent stream in a shift conversion unit further includes reducing a pollutant from the sulfur recovery effluent unit tail gas stream. The pollutant may include any suitable substance and/or material, such as carbonyl sulfide, hydrogen sulfide, organic sulfur compounds, and/or the like.

According to one embodiment, the invention may include an apparatus for reducing pollutants. The apparatus may include a sulfur recovery unit effluent tail gas stream, a shift conversion unit connected to the sulfur recovery unit effluent tail gas stream, a shift conversion unit effluent stream connected to the shift conversion unit, an acid gas removal unit connected to the shift conversion unit effluent stream, a hydrogen stream connected to the acid gas removal unit, optionally a carbon dioxide stream connected to the acid gas removal unit, a hydrogen sulfide stream connected to the acid gas removal unit, a sulfur recovery unit connected to the hydrogen sulfide stream and the sulfur recovery unit effluent tail gas stream, and/or a sulfur stream connected to the sulfur recovery unit.

Apparatus broadly refers to one or more devices and/or equipment to perform and/or accomplish a step, a task, and/or an outcome. Apparatuses may use mechanical principles, chemical principles, thermodynamic principles, and/or the like. The apparatus and any parts and/or portions of the apparatus may have any of the features and/or characteristics with respect to processes and/or apparatuses described within this specification.

Device broadly refers to a piece of equipment and/or a mechanism, such as to perform and/or accomplish a step, a task, and/or an outcome. One or more devices may form a portion of a unit and/or an apparatus.

According to one embodiment, the apparatus may also include a hydrogenation unit on the sulfur recovery unit effluent tail gas stream, a washing unit on the sulfur recovery unit effluent tail gas stream, a cooling unit on the sulfur recovery unit effluent tail gas stream, optionally a drying unit on the sulfur recovery unit effluent tail gas stream, and/or a compression unit on the sulfur recovery unit effluent tail gas stream.

According to one embodiment, the apparatus may include where the shift conversion unit includes one or more shift converters of decreasing temperature, and the sulfur recovery unit effluent tail gas stream connects to one or more of the one or more of the shift converters.

The apparatus may include a tail gas treatment unit on the sulfur recovery unit effluent tail gas stream, and a second hydrogen sulfide stream connected to the tail gas treatment unit and the sulfur recovery unit, such as for returning hydrogen sulfide from the tail gas treatment unit for additional recovery.

According to one embodiment, the apparatus may include where the reactor unit includes at least one of a gasification unit, a reforming unit, a partial oxidation unit, a pyrolysis unit, and/or the like.

The apparatus may include at least one of a steam generation unit, an electricity generation unit, an ammonia generation unit, a methanol generation unit, a synthetic hydrocarbon product generation unit, and/or the like, such as to consume and/or use at least a portion of the hydrogen stream.

The apparatus may also include a carbon sequestration unit, an enhanced oil recovery unit, an industrial gas supply unit, and/or the like.

Embodiments with stand alone shift converters (non-recycle) for pollutant destruction and/or removal are within the scope of this invention.

According to one embodiment, the invention may include an apparatus for producing syngas. The apparatus may include a feedstock stream, a reactor unit connected to the feedstock stream, a reactor unit effluent stream connected to the reactor unit, and a shift conversion unit connected to the reactor unit effluent stream. The shift conversion unit may include one or more shift conversion devices. The apparatus may include a shift conversion unit effluent stream connected to the shift conversion unit, an acid gas removal unit connected to the shift conversion unit effluent stream, a hydrogen stream connected to the acid gas removal unit, a hydrogen sulfide stream connected to the acid gas removal unit, a carbon dioxide stream connected to the acid gas removal unit, a sulfur recovery unit connected to the hydrogen sulfide stream, a sulfur stream connected to the sulfur recovery unit, and a sulfur recovery unit effluent tail gas stream connected to the sulfur recovery unit and the shift conversion unit.

The apparatus may further include a hydrogenation unit on the sulfur recovery unit effluent tail gas stream, a washing unit on the sulfur recovery unit effluent tail gas stream, and a cooling unit on the sulfur recovery unit effluent tail gas stream.

The shift conversion unit may include one or more shift converters of decreasing temperature and the sulfur recovery unit effluent tail gas stream connects to one or more of the one or more shift converters.

The apparatus may further include a tail gas treatment unit to form a second hydrogen sulfide stream from the sulfur recovery unit effluent tail gas stream and to form a tail gas treatment unit effluent stream, the second hydrogen sulfide stream connected to the sulfur recovery unit, a drying unit on the tail gas treatment unit effluent stream, a compression unit on the tail gas treatment unit effluent stream, and the tail gas treatment unit effluent connected to the shift conversion unit.

The reactor unit may include any suitable device and/or equipment, such as at least one of a gasification unit, a reforming unit, a partial oxidation unit, a pyrolysis unit, and/or the like. The reactor unit may form a portion of a larger plant, such as a power plant, a petroleum refinery, a chemical production complex, and/or the like. The plant may include simple cycle gas turbines, combined cycle gas turbines, heat recovery units, boilers, steam generators, and/or the like. The plant may include an integrated gasification combined cycle (IGCC) configuration optionally with carbon sequestration. Desirably, but not necessarily, the plant operates with reduced carbon emissions compared to plants of conventional configuration, such as a coal fired boiler exhausting directly to the atmosphere.

The apparatus may further include a steam generation unit, an electricity generation unit, an ammonia generation unit, a methanol generation unit, a synthetic hydrocarbon product generation unit, and/or the like.

According to one embodiment, the apparatus includes where the carbon dioxide stream connects to a carbon sequestration unit with a carbon sequestration stream, an enhanced oil recovery unit with an enhanced oil recovery stream, an industrial gas supply unit with an industrial gas supply stream, and/or the like.

As used herein the terms “has”, “having”, “comprising” “with”, “containing”, and “including” are open and inclusive expressions. Alternately, the term “consisting” is a closed and exclusive expression. Should any ambiguity exist in construing any term in the claims or the specification, the intent of the drafter is toward open and inclusive expressions.

As used herein the term “and/or the like” provides support for any and all individual and combinations of items and/or members in a list, as well as support for equivalents of individual and combinations of items and/or members.

Regarding an order, number, sequence, and/or limit of repetition for steps in a method or process, the drafter intends no implied order, number, sequence and/or limit of repetition for the steps to the scope of the invention, unless explicitly provided.

Regarding ranges, ranges are to be construed as including all points between upper values and lower values, such as to provide support for all possible ranges contained between the upper values and the lower values including ranges with no upper bound and/or lower bound.

It will be apparent to those skilled in the art that various modifications and variations can be made in the disclosed structures and methods without departing from the scope or spirit of the invention. Particularly, descriptions of any one embodiment can be freely combined with descriptions of other embodiments to result in combinations and/or variations of two or more elements and/or limitations. Other embodiments of the invention will be apparent to those skilled in the art from consideration of the specification and practice of the invention disclosed herein. It is intended that the specification and examples be considered exemplary only, with a true scope and spirit of the invention being indicated by the following claims.

What is claimed is:

1. A process for reducing pollutants, the process comprising:
reacting a first stream comprising at least one sulfur compound to form a second stream comprising carbon dioxide, hydrogen sulfide, and a reduced amount of the at least one sulfur compound;
recovering elemental sulfur from a portion of the second stream to form a third steam comprising the at least one sulfur compound, carbon dioxide, and a reduced amount of hydrogen sulfide; and
directing at least a portion of the third stream to form a portion of the first stream.

2. The process of claim 1, wherein the at least one sulfur compound comprises carbonyl sulfide, hydrogen sulfide, organic sulfur compounds, or combinations thereof.

3. The process of claim 1, further comprising:
optionally removing free oxygen from at least a portion of the third stream;
optionally drying at least a portion of the third stream; and
compressing at least portion of the third stream.

4. The process of claim 1, further comprising:
hydrogenating at least a portion of the third stream;
optionally drying at least a portion of the third stream; and
compressing at least portion of the third stream.

5. The process of claim 1, further comprising:
hydrogenating at least a portion of the third stream;
washing at least portion of the third stream;
cooling at least portion of the third stream;
optionally drying at least a portion of the third stream; and
compressing at least a portion of the third stream.

6. The process of claim 1, further comprising:
hydrogenating at least a portion of the third stream;
washing at least a portion of the third stream;
cooling at least a portion of the third stream;
optionally drying at least a portion of the third stream;
compressing at least a portion of the third stream; and
treating at least a portion of the third stream in a tail gas treatment unit.

7. The process of claim 1, wherein:
the reacting occurs with one or more catalysts of decreasing temperature; and
the third stream connects to one or more of the one or more catalysts.

8. The process of claim 1, further comprising:
separating a hydrogen sulfide stream from a portion of the third stream;
directing at least a portion of the hydrogen sulfide stream to combine with at least a portion of the second stream;
drying at least a portion of the third stream;
compressing at least a portion of the third stream; and
directing at least a portion of the third stream to one or more catalysts.

9. The process of claim 1, further comprising reacting a feedstock stream to form the first stream, where the reacting comprises gasification, reforming, partial oxidation, pyrolysis, or combinations thereof.

10. The process of claim 1, further comprising:
separating a hydrogen stream from a portion of the second stream; and
using at least a portion of the hydrogen stream to produce steam, electricity, ammonia, methanol, synthetic hydrocarbon products, or combinations thereof.

11. The process of claim 1, further comprising:
separating a carbon dioxide stream from a portion of the second stream; and
using at least a portion of the carbon dioxide stream for carbon sequestration, enhanced oil recovery, industrial gas supply, or combinations thereof.

12. A process of producing clean syngas, the process comprising:
reacting a feedstock stream in a reactor unit to form a reactor unit effluent stream;
converting the reactor unit effluent stream in a shift conversion unit to form a shift conversion unit effluent stream;
separating the shift conversion unit effluent stream in an acid gas removal unit to form a hydrogen stream, a hydrogen sulfide acid gas stream, and a carbon dioxide stream;
recovering elemental sulfur from the hydrogen sulfide acid gas stream in a sulfur recovery unit to form a sulfur stream and a sulfur recovery unit effluent tail gas stream; and
connecting the sulfur recovery unit effluent tail gas stream to the shift conversion unit.

13. The process of claim 12, further comprising:
hydrogenating the sulfur recovery unit effluent tail gas stream;
washing the sulfur recovery unit effluent tail gas stream;
cooling the sulfur recovery unit effluent tail gas stream;
optionally drying the sulfur recovery unit effluent tail gas stream; and
compressing the sulfur recovery unit effluent tail gas stream.

14. The process of claim 12, wherein:
the shift conversion unit comprises one or more shift converters of decreasing temperature; and
the sulfur recovery unit effluent tail gas stream connects to one or more of the one or more shift converters.

15. The process of claim 14, wherein the sulfur recovery unit effluent tail gas stream connects to a first shift converter.

16. The process of claim 12, further comprising:
separating a second hydrogen sulfide stream from the sulfur recovery unit effluent tail gas stream in a tail gas treatment unit; and
connecting the second hydrogen sulfide stream back to the sulfur recovery unit.

17. The process of claim 12, wherein the reactor unit comprises a gasification unit, a reforming unit, a partial oxidation unit, a pyrolysis unit, or combinations thereof.

18. The process of claim 12, further comprising using the hydrogen stream to produce steam, electricity, ammonia, methanol, synthetic hydrocarbon products, or combinations thereof.

19. The process of claim 12, further comprising using the carbon dioxide stream for carbon sequestration, enhanced oil recovery, industrial gas supply, or combinations thereof.

20. The process of claim 12, wherein the converting the reactor unit effluent stream in a shift conversion unit further comprises reducing a pollutant from the sulfur recovery effluent unit tail gas stream.

21. The process of claim 20, wherein the pollutant comprises carbonyl sulfide, hydrogen sulfide, organic sulfur compounds, or combinations thereof.

22. An apparatus for reducing pollutants, the apparatus comprising:
a sulfur recovery unit effluent tail gas stream;
a shift conversion unit connected to the sulfur recovery unit effluent tail gas stream;
a shift conversion unit effluent stream connected to the shift conversion unit;
an acid gas removal unit connected to the shift conversion unit effluent stream;
a hydrogen stream connected to the acid gas removal unit;
optionally a carbon dioxide stream connected to the acid gas removal unit;
a hydrogen sulfide stream connected to the acid gas removal unit;
a sulfur recovery unit connected to the hydrogen sulfide stream and the sulfur recovery unit effluent tail gas stream; and
a sulfur stream connected to the sulfur recovery unit.

23. The apparatus of claim 22, further comprising:
a hydrogenation unit on the sulfur recovery unit effluent tail gas stream;
a washing unit on the sulfur recovery unit effluent tail gas stream;
a cooling unit on the sulfur recovery unit effluent tail gas stream;
optionally a drying unit on the sulfur recovery unit effluent tail gas stream; and
a compression unit on the sulfur recovery unit effluent tail gas stream.

24. The apparatus of claim 22, wherein:
the shift conversion unit comprises one or more shift converters of decreasing temperature; and
the sulfur recovery unit effluent tail gas stream connects to one or more of the one or more of the shift converters.

25. The apparatus of claim 22, further comprising:
a tail gas treatment unit on the sulfur recovery unit effluent tail gas stream; and
a second hydrogen sulfide stream connected to the tail gas treatment unit and the sulfur recovery unit.

26. The apparatus of claim 22, wherein the reactor unit comprises a gasification unit, a reforming unit, a partial oxidation unit, a pyrolysis unit, or combinations thereof.

27. The apparatus of claim 22, further comprising a steam generation unit, an electricity generation unit, an ammonia generation unit, a methanol generation unit, a synthetic hydrocarbon product generation unit, or combinations thereof.

28. The apparatus of claim 22, further comprising a carbon sequestration unit, an enhanced oil recovery unit, an industrial gas supply unit, or combinations thereof.

29. An apparatus for producing syngas, the apparatus comprising:
a feedstock stream;
a reactor unit connected to the feedstock stream;
a reactor unit effluent stream connected to the reactor unit;
a shift conversion unit connected to the reactor unit effluent stream, where the shift conversion unit comprises of one or more shift conversion devices;
a shift conversion unit effluent stream connected to the shift conversion unit;
an acid gas removal unit connected to the shift conversion unit effluent stream;
a hydrogen stream connected to the acid gas removal unit;
a hydrogen sulfide stream connected to the acid gas removal unit;
a carbon dioxide stream connected to the acid gas removal unit;
a sulfur recovery unit connected to the hydrogen sulfide stream;
a sulfur stream connected to the sulfur recovery unit; and
a sulfur recovery unit effluent tail gas stream connected to the sulfur recovery unit and the shift conversion unit.

30. The apparatus of claim 29, further comprising:
a hydrogenation unit on the sulfur recovery unit effluent tail gas stream;
a washing unit on the sulfur recovery unit effluent tail gas stream; and
a cooling unit on the sulfur recovery unit effluent tail gas stream.

31. The apparatus of claim 29, wherein:
the shift conversion unit comprises one or more shift converters of decreasing temperature; and
the sulfur recovery unit effluent tail gas stream connects to one or more of the one or more shift converters.

32. The apparatus of claim 29, further comprising:
a tail gas treatment unit to form a second hydrogen sulfide stream from the sulfur recovery unit effluent tail gas stream and to form a tail gas treatment unit effluent stream;
the second hydrogen sulfide stream connected to the sulfur recovery unit;
a drying unit on the tail gas treatment unit effluent stream;
a compression unit on the tail gas treatment unit effluent stream; and
the tail gas treatment unit effluent connected to the shift conversion unit.

33. The apparatus of claim 29, wherein the reactor unit comprises a gasification unit, a reforming unit, a partial oxidation unit, a pyrolysis unit, or combinations thereof.

34. The apparatus of claim 29, further comprising a steam generation unit, an electricity generation unit, an ammonia generation unit, a methanol generation unit, a synthetic hydrocarbon product generation unit, or combinations thereof.
